(19) United States
(12) Patent Application Publication
(10) Pub. No.: US 2015/0125126 A1
(43) Pub. Date: May 7, 2015

(54) DETECTION SYSTEM IN A VEHICLE FOR RECORDING THE SPEAKING ACTIVITY OF A VEHICLE OCCUPANT

(71) Applicant: Robert Bosch GmbH, Stuttgart (DE)

(72) Inventor: Philippe Dreuw, Heersum (DE)

(21) Appl. No.: 14/532,736

(22) Filed: Nov. 4, 2014

(30) Foreign Application Priority Data
Nov. 7, 2013 (DE) 10 2013 222 645.4

(51) Int. Cl. H04N 5/77; B60W 40/08; G08B 21/06

(52) U.S. Cl. CPC H04N 5/77; G08B 21/06; B60W 40/08; B60W 2540/26; B60W 2040/0818
USPC 386/226

(57) ABSTRACT

A detection system in a vehicle for detecting the speaking activity of a vehicle occupant includes: a video recording system for recording the posture of the head and/or of the motions of the lips; an evaluation device; and a signal generating device.

### BACKGROUND OF THE INVENTION

1. Field of the Invention

The present invention relates to a detection system in a vehicle for recording the speaking activity of a vehicle occupant.

2. Description of the Related Art

A detection system is known from published German patent application document DE 10 2011 084 552 A1 for recording the state of alertness of the driver of a motor vehicle. The system includes a camera integrated into a mobile device, which is directed at the eyes of the driver, the images taken being examined for typical patterns giving insight into the state of alertness. The eyelid closure activity and the iris activity are monitored, which give warning signs of a critical drowsiness. If the measure of drowsiness exceeds a boundary value, a warning is output.

Published European patent document EP 1 732 028 B1 describes a method for detecting the eyes of a driver in a vehicle, in which the face of the driver is taken by a video camera and examined for typical feature patterns.

### BRIEF SUMMARY OF THE INVENTION

The present invention is based on the object of increasing the travel safety in vehicles.

The detection system according to the present invention is able to be integrated into motor vehicles, and is used to detect the state of alertness of the driver. The detection system includes a video recording device, an evaluation device as well as a signal generating device, the posture of the head and/or the motions of the lips of one or more vehicle occupants being recorded via the video recording device. These measured data are supplied to the evaluation device, in which an evaluation takes place and a signal is generated if the posture of the head and/or the motions of the lips lead to the conclusion of reduced alertness of the driver.

Using the detection system according to the present invention, it is thus possible to ascertain speaking activities of one or more vehicle occupants, based on video data of a video recording system, from which, for example, by making a comparison to specified patterns of posture or motion patterns of the head and/or the lips, one is able to draw conclusions on speaking activity which, with respect to their scope and their intensity allow one to conclude that there is distraction, and thus a reduced alertness of the driver.

Accordingly, in a method for operating the detection system using the video recording system, the evaluation device and the signal generating device, the posture of the head and/or the motions of the lips of one or more vehicle occupants are recorded and a signal representing a reduced alertness of the driver is generated, if the posture of the head and/or the motions of the lips allow one to conclude that there is reduced alertness on the part of the driver.

It may be sufficient to ascertain only the posture of the head and/or the motions of the lips of a single vehicle occupant, for instance, of the driver, and to compare these to stored patterns of motion. From the comparison, one is able to conclude upon the intensity, and thus upon the distraction or rather, the reduced alertness of the driver. The person being observed in the vehicle, via the video recording system, may be the driver, but basically also a passenger coming into consideration who, by his speaking activity, leads to a distraction or rather, a reduced alertness of the driver.

According to one further expedient embodiment, the speaking activity of a plurality of vehicle occupants is examined. For this purpose, the video recording device may be directed at the head of a plurality of vehicle occupants, or may include a plurality of video cameras, in order to be able to take various persons at the same time. The head and the lip activities of a plurality of vehicle occupants are registered via the video recording device, the head and the lips of the driver being also advantageously taken. While a plurality of vehicle occupants is being observed, a conversation between vehicle occupants is able to be registered, particularly if the driver is participating. Because of this, greater safety is a given with respect to the detecting of the distraction and the reduced alertness state of the driver.

The reduced state of alertness may be ascertained either only from the posture of the head or the motion of the head of one or more vehicle occupants, or only from the motions of the lips of one or more vehicle occupants. It is also possible, with respect to a vehicle occupant, only to observe the head posture and/or the head motion, and with respect to an additional vehicle occupant, to observe only the motions of the lips, and evaluate these with respect to the reduced state of alertness of the driver. It is preferred, however, in the case of all vehicle occupants observed, to record and evaluate both the posture of the head and the motion of the head as well as the motions of the lips.

According to one further expedient embodiment, the detection system also includes an audio recording device to record the speaking activity. The audio recording device includes at least one microphone in the vehicle to record the speech of one or more vehicle occupants. The audio recording device is used in support of the video recording system, and supplies additional information on the speaking activity in the vehicle, which permits an improved assignment to the various vehicle occupants in the vehicle.

Via the audio recording device, particularly in connection with the video recording device, it may be determined whether one or several vehicle occupants is/are speaking. If necessary, the speech content (speech detection) may also be recorded via the audio recording device, whereupon conclusions may be drawn upon the identity of the speakers and/or of the person(s) addressed. For instance, it is possible to detect whether two passengers are talking about the driver, which can also lead to the distraction of the driver. The detection and evaluation of the words spoken takes place also in addition to the signals of the video recording device, and is thus used in support of the detection of the state of alertness of the driver.

If a reduced alertness of the driver is determined, a signal is generated which may be used further in various ways. For example, in the vehicle, a warning signal may be emitted in an optical, acoustical or haptic manner, in order to draw attention to the reduced state of alertness of the driver, and to urge him to concentrate his attention fully on the traffic situation again However, it is also possible to utilize the signal to the automatic setting of an assembly in the vehicle or of a driver assistance system, for example, to trigger a driver assistance system such as a braking process carried out automatically or a steering compensation motion. Furthermore, it is also possible, by reparameterization, to set a lowered triggering threshold in an assembly or a driver assistance system, for instance, in an electronic stability program (ESP), in order to make allowance for the reduced state of alertness of the driver by the early triggering of the driver assistance system.

As the video recording device one may consider, for instance, an infrared-sensitive camera, which may be developed perhaps as an LED camera, which radiates a weak infrared light which leads to a reflection in the eyes or rather the cornea of the vehicle occupant that is taken by the camera. It is thereby possible to identify the pupils in the eye on the image, and to determine the direction of view of the driver. The posture and/or the motion of the head may advantageously also be determined via the camera system.

### BRIEF DESCRIPTION OF THE DRAWINGS

FIG. 1 shows a schematic representation of a detection system in a vehicle for recording the speaking activity of a vehicle occupant.

FIG. 2 shows the passenger compartment of a motor vehicle in a perspective view.

FIG. 3 shows a schematic representation of an infrared-sensitive LED camera for detecting the facial region of the driver.

### DETAILED DESCRIPTION OF THE INVENTION

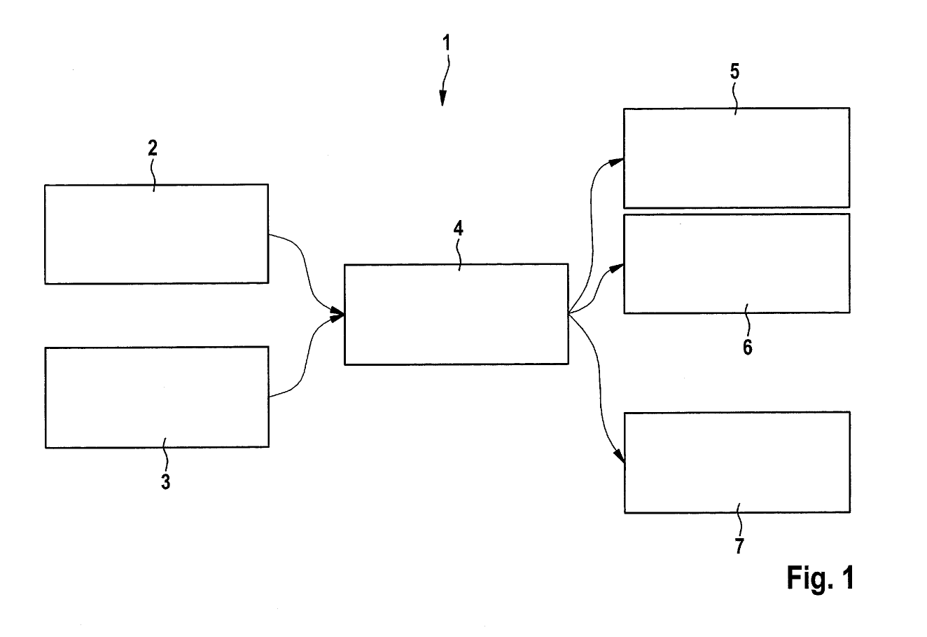

FIG. 1 shows a detection system 1 that is installed in a vehicle, and using which the speaking activities of one or more vehicle occupants are able to be detected, from which a conclusion may be drawn in the detection system upon there being a reduced alertness of the driver. Detection system 1 includes a video recording device 3 and an audio recording device 2 for recording optical and acoustical signals of one or more vehicle occupants in the vehicle. Detection system 1 furthermore includes an arithmetic and evaluation unit 4, in which the data from recording devices 2 and 3 are evaluated and output signals are generated for the actuation of units 5, 6 and 7.

Units 5, 6 and 7 are implementation devices for outputting warning signals in an acoustical, optical and haptic manner, that is, for the output of a warning tone, a warning signal in a display or a vibration alarm such as in the steering wheel or in the driver's seat. Units 5, 6 and 7 may also include a settable assembly in the vehicle, such as a drive motor, the braking and/or steering system, the assembly being able to be actuated via the output signals of the arithmetic and evaluation unit 4. To units 5, 6, 7, a driver assistance system may belong, if necessary, for instance, for actuating the braking system or an electronic stability program (ESP), a reparameterizing of the driver assistance system or the triggering of the driver assistance system being carried out via the output signals of arithmetic and evaluation unit 4.

The posture of the head and the motion of the head of a vehicle occupant as well as the motions of the lips may be recorded via video recording device 3 of detection system 1. The posture of the head or the motion of the head and the motions of the lips may be recorded either of only one vehicle occupant or of a plurality of vehicle occupants. With this concept, it is possible to record a speaking activity of at least one vehicle occupant and from this, in arithmetic and evaluation unit 4, to conclude upon the state of alertness of the driver. If a distraction of the driver, that is, a reduced state of alertness is determined, an output signal is carried out as a warning signal for the optical, acoustical and/or haptic implementation, or rather an actuation of an assembly or a driver assistance system.

Audio recording device 2 is able to determine in an acoustical manner the speaking activity in the vehicle. According to one simple embodiment, only via one microphone, the speaking activity in the vehicle is registered, which, if necessary, is able to be assigned specifically to one vehicle occupant in connection with the signals of the video recording device.

In one expanded embodiment, the content of the speech is also analyzed via the audio detection device, which permits a targeted association of the speech content with a certain vehicle occupant. This procedure makes it possible to analyze a conversation among the passengers, in which the driver does not necessarily have to take part, and at the same time to produce a reference to the driver, for example, in that the driver is addressed by the passengers, without himself taking part in the conversation.

It is also possible, via the video recording device and the audio recording device to register only one speaking activity of the driver, for example during a telephone conversation of the driver, and from this to conclude that there exists a reduced state of alertness of the driver.

In response to the analysis of the measuring signals from the video recording device and the audio recording device, there follows a comparison to stored optical or acoustical patterns, for instance to typical postures of the head or motions of the head and to typical motions of the lips. If the comparison between the signals picked up and the patterns stored yields that there is increased speaking activity, this may be interpreted as a reduced state of alertness which, as described above, leads to the output of a warning signal or to the setting of an assembly or a driver assistance system.

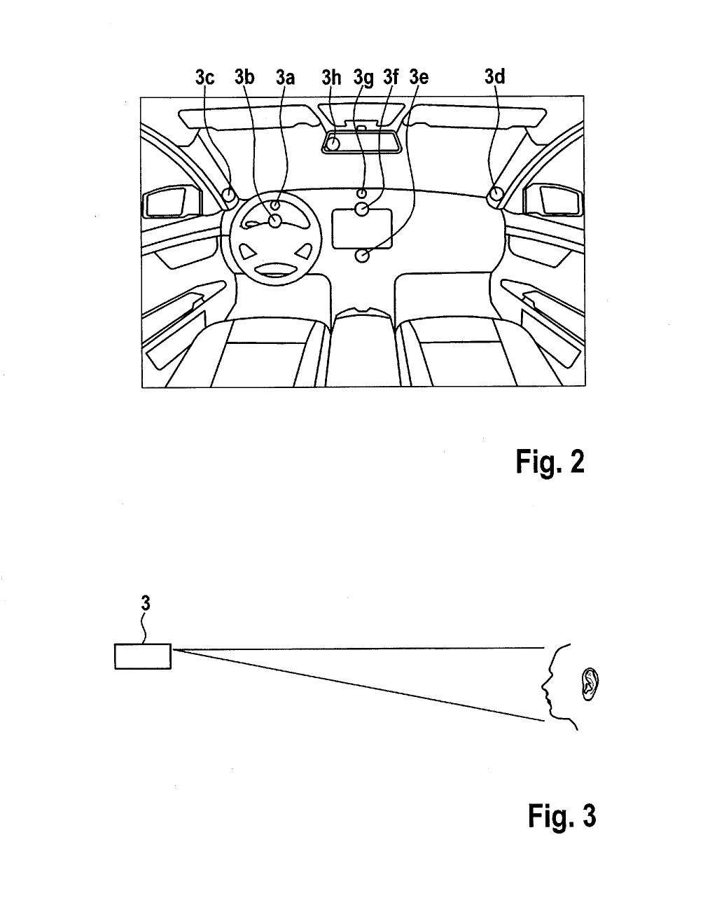

FIG. 2 shows the passenger compartment of a motor vehicle having diverse video recording devices 3 at different positions. A video recording device 3a is located in the dashboard area, directly below the steering wheel. Video recording device 3b is located on the steering wheel, video recording devices 3c and 3d are located in the left and right A-column, respectively. Video recording devices 3e, 3f and 3g are located at different heights in the middle of the dashboard area. Video recording device 3h is integrated into the internal rearview mirror.

In the passenger compartment of the vehicle, a plurality of video recording devices are situated in order to be able to take the posture of the head and the head motion and the motions of the lips of various vehicle occupants at different positions of the head.

Video recording devices 3, as shown in FIG. 3, are preferably directed at the head of the vehicle occupants in such a way that the facial region is able to be recorded together with the lips.

What is claimed is:

1. A detection system in a vehicle for detecting a reduced alertness of a driver of a vehicle, comprising:
a video recording device for recording at least one of a posture of a head and motions of lips;
an evaluation device; and
a signal generating device for generating a signal if the at least one of the posture of the head and the motions of the lips indicate a reduced alertness of the driver.

2. The detection system as recited in claim 1, wherein a reduced alertness of the driver is present in the event of a speaking activity of a vehicle occupant exceeding a predefined boundary value.

3. The detection system as recited in claim 2, wherein the vehicle occupant is the driver.

4. The detection system as recited in claim 2, wherein the vehicle occupant is a passenger in the vehicle.

5. The detection system as recited in claim 2, wherein a reduced alertness of the driver is present if, in the case of at least one vehicle occupant, both of the following are present: (i) a specified lip motion pattern and (ii) at least one of a specified posture of the head and a specified head motion.

6. The detection system as recited in claim 2, further comprising:
an audio recording device for at least one of recording the speaking activity and detecting speech.

7. The detection system as recited in claim 6, wherein from the signals of the audio detection device a conclusion is drawn as to at least one of (i) whether the driver is speaking and (ii) whether the driver is being spoken about.

8. The detection system as recited in claim 6, wherein multiple vehicle occupants are recorded simultaneously via the recording devices.

9. The detection system as recited in claim 8, wherein the signal representing the reduced alertness of the driver is output as a warning signal in the vehicle.

10. The detection system as recited in claim 9, wherein a driver assistance system in the vehicle is affected by the signal representing the reduced alertness of the driver.

11. A method for operating the detection system for detecting a reduced alertness of a driver of a vehicle, the method comprising:
recording, by a video recording device, at least one of a posture of a head and motions of a lip; and
generating, by a signal generating device, a signal representing a reduced alertness of the driver if the at least one of the posture of the head and the motion of the lip indicates a reduced alertness of the driver.
